(19) United States
(12) Patent Application Publication
(10) Pub. No.: US 2017/0279950 A1
(43) Pub. Date: Sep. 28, 2017

(54) COMMUNICATION DEVICE CONTROL WITH EXTERNAL ACCESSORY

(71) Applicant: PAUMAX OY, Salo (FI)

(72) Inventors: Pasi AURANEN, Salo (FI); Juha YLONEN, Aura (FI); Maximilian LEROUX, Brighton, MA (US)

(21) Appl. No.: 15/505,002

(22) PCT Filed: Aug. 20, 2015
(86) PCT No.: PCT/FI2015/050536

§ 371 Date: Feb. 17, 2017

Related U.S. Application Data
(60) Provisional application No. 62/039,968, filed on Aug. 21, 2014.

(51) Int. Cl. H04M 1/725; H04W 4/00; H04W 4/10

(52) U.S. Cl. CPC H04M 1/7253; H04W 4/10; H04W 4/008; H04M 2250/02

(57) ABSTRACT

Disclosed is a communication device (102) that can be hosting a communication application (112) and/or software, such as PTT/VoIP application, which is at least partially controlled and supplemented with payload data by at least one accessory to provide remote UI capabilities, to be used in a communications system as system element, with an UI feature and/or accessory device for communicating commands, signaling data and/or voice/audio data. Also disclosed is an accessory device as a system element of the communications system.

### FIELD OF THE INVENTION

The present invention relates generally to wireless communication. In particular, however not exclusively, the present invention pertains to the utilization of at least one accessory device such as an RSM (Remote Speaker Microphone) in connection with a mobile communication device capable of executing various applications.

### BACKGROUND

A variety of communications applications exists e.g. in the field of Push-to-Talk (PTT) and Voice-over-IP (VoIP) for both computer and mobile platforms such as cell phones or smartphones.

Traditionally, such platforms and devices have been mostly designed as self-containing or ‘stand-alone’ elements. In other words, the users have interacted with the platforms/devices and related software through integrated user interfaces thereof, typically a keypad, some buttons or a touch screen. When a communication and/or control accessory such as RSM device was connected to the target platform/device, each application developer was required to modify their software in co-operation with the RSM device manufacturer. This was practically unfeasible as the application developers were have to be persuaded to support each potential device by the RSM manufacturers. For example, sending PTT commands over a Bluetooth (BT) link was not supported by the existing BT standards. An RSM device thus needed specific firmware and software to generate PTT commands understood by a predetermined communication application like Push to Talk over Cellular (PoC) application running on a mobile device. Correspondingly, the PoC-application required RSM manufacturer-specific support to be able to interpret the received proprietary commands.

Finally, U.S. patent application Ser. No. 13/884,659, which is incorporated herein by reference in its entirety, handed out an applicable solution to the utilization of accessories such as RSM devices, from the standpoint of above defects. A mobile arrangement, such as a mobile communication-enabled device, may comprise a user interface, such as a keypad, configured to receive user input, a wireless data transfer interface, such as Bluetooth-compliant interface, configured to receive a command, such as a PTT command, sent by an external accessory, such as an RSM device, wirelessly connected to the mobile arrangement, and an interfacing logic configured to map the received command to a predetermined command locally providable via the user interface to a communication application running on the mobile arrangement and capable of receiving user input via the user interface so as to enable utilization of said communication application through the accessory.

For instance, a function of a communication application, such as a PTT request, may be linked with a certain UI feature, such as a key/button (e.g. ‘PTT’ button), such that the activation of the certain UI feature (depressing the button, for example) then generates an input signal commanding the application to trigger the function. The mapping feature disclosed above may generate such a signal in response to the received accessory-originated, potentially user-initiated (e.g., via button press or other UI feature) command to imitate true locally provided user input.

Devices such as cell phones and accessories like RSM may indeed follow e.g. the Bluetooth-specification. So-called Classic Bluetooth™ contains a number of different profiles, i.e. communication-related specifications, for a myriad of purposes such as audio/voice distribution, hands-free use, headset use, intercom or walkie-talkie type communication, serial port emulation, etc. Some of the profiles may be used for audio/voice transfer, whereas some others enable convenient signaling between the communicating entities. For example, A2DP (Advanced Audio Distribution Profile), HFP (Hands-Free Profile), or HSP (Headset Profile) profiles may be harnessed for establishing a desired type of an audio link while a Serial Port Profile (SPP) can be used for signaling control commands such as PTT control commands responsive to e.g. a human-controllable button in an RSM between the RSM and remote host device like a mobile phone.

Generally, the available profiles of Classic Bluetooth work fine, i.e. audio/voice signals are transferred intelligibly and signaling such as control commands eventually reaches the recipient. However, we have found that in practical circumstances the perceived subjective performance is anything but optimal, which is mainly due to latency issues.

E.g. the SPP link itself is fast enough in terms of data throughput, but suffers from variable delays (typically in the order of magnitude of about 50 to 1000 ms) when activating the link. This may cause user dissatisfaction regarding the accumulated delay over the Classic Bluetooth when pressing e.g. a PTT button in an accessory and it easily takes a second until the command reaches a target communication application in the phone and the voice transmission mode is finally activated. As the communication application running in the phone or other host device opens the audio link to the RSM device, and potentially also negotiates the transmission uplink over Wi-fi or cellular data connection, for instance, it is mandatory to keep related delays as low as possible. In addition to mere user inconvenience arising from the lag between issuing control commands and receiving the response, certain professional applications such as Police and Public Safety applications do not simply tolerate large delays and therefore a solution to at least alleviate such latency problem shall be sought after.

### SUMMARY

In one embodiment, a communication device, such as a mobile communication device may be configured to communicate (receive and/or transmit) audio data such as voice data with a wirelessly connected first accessory over a first wireless connection, preferably Classic Bluetooth™-compliant connection, the communication device being further configured to communicate (receive and/or transmit) with the first and/or second accessory, related signaling information optionally indicative of user-initiated control commands and potentially including receiving an indication of depressing or otherwise activating a button, e.g. PTT button or other UI feature of the first or second accessory, over a second, technology-wise different wireless connection, preferably Bluetooth Low Energy (BLE, Bluetooth LE or Bluetooth Smart)™.

A communication device according to an embodiment of the invention comprises a configuration for hosting a communication application and/or software, such as a PTT/VoIP application, for communication of audio data, such as voice data, with a wirelessly connected first accessory over a first wireless connection, such as Classic Bluetooth-compliant connection or Bluetooth Low Energy-compliant connection (BLE, Bluetooth LE or Bluetooth Smart), the communication device being further configured to be at least partially controlled and supplemented with payload data by at least one accessory to provide remote UI features and/or capabilities, the signaling being configured to occur via a second wireless connection, preferably Bluetooth Low Energy-compliant connection (BLE, Bluetooth LE or Bluetooth Smart). In a related embodiment, transferring the signaling information, such as user-initiated control commands, comprises at least one action selected from the group consisting of: receiving an indication of a PTT button activation or activation of other UI feature in the accessory (remote UI device), receiving an indication of a user-initiated control action targeted to a communication application executed or executable in the communication device, transmitting a wake up signal or other activation signal to turn on the first and/or second accessory or to activate a predetermined feature or state thereof, and transmitting a sleep signal or other deactivation signal to turn off the first and/or second accessory/remote UI device or to deactivate or turn off a predetermined feature or state thereof.

Thus, the communication device may indeed act as a host for communication application/software such as PTT/VoIP application that is at least partially controlled and supplemented with payload (audio/voice) data by at least one accessory providing remote UI capabilities.

Optionally, two or more accessories may be applied for controlling the communication device/communication application substantially simultaneously and/or regarding at least the same communications connection or session. For example, one accessory device may be used for the provision of user input (control) commands to the communication device/application whereas one other accessory device may be applied for audio transfer, which may refer to capturing and obtaining e.g. voice input from the user and providing distant end audiolvoice data (e.g. voice signal of a remote party in connection with voice call/discussion and/or audio/voice instructions such as status indications of the application) back to him/her.

The communication device may include or consist of e.g. a cellular phone, a so-called smartphone or a communications-enabled PDA (personal digital assistant), a tablet, a phablet, and/or vehicle-installed communication equipment among other options.

In another embodiment, a wireless communications-enabled accessory device or an arrangement comprising at least first and second accessory devices, may be configured to transmit to or generally communicate audio data, such as voice signals, with a communication device over a first wireless connection, preferably Classic Bluetooth™-compliant connection, and further configured to communicate therewith related signaling information, optionally including transmitting an indication of depressing or otherwise actuating a button, e.g. PTT button (to activate audio/voice transmission), or other UI feature, over a second, different wireless connection, preferably compliant with Bluetooth Low Energy (BLE, Bluetooth LE or Bluetooth Smart)™.

According to an embodiment, communications device and/or its hosting communication application is configured optionally or in addition to communicate said audio data by utilization of Bluetooth Low Energy (BLE, Bluetooth LE or Bluetooth Smart) protocol.

The accessory/remote UI device may comprise a number of, or preferably a plurality of, user actuable (manually actuable) UI features such as a number of buttons, switches, keys, and/or a touch display/surface that may locally control feature(s) of the device and/or be associated with predetermined control signal(s) transmitted wirelessly over the second connection to control the communication device via application running thereon, for instance. Yet, the accessory device may include a microphone or similar transducer(s) for converting audio such as speech input into electronic and preferably digital form for optional (local) processing such as encoding and ultimately transmission over the first connection.

Likewise, the accessory may include a loudspeaker or other audio reproduction means to audibly reproduce sound signals wirelessly received in digital form from the communication device/application.

The accessory may be optionally activated or woken up (e.g. from off, stand-by or idle state), or at least a feature thereof such as a communications feature, may be triggered on/off responsive to a predetermined signal received over the second connection, preferably BLE, e.g. from the communication device. The communication device may send such signal responsive to user action on the (integral) UI of the communication device itself and/or to a predefined event occurring at the communication device, such as launching of a communication application, establishing a connection or call therethrough, etc. This feature could also be implemented as a stand-alone feature in various other use scenarios wherein BLE or substantially similar, advantageous technology is available for data transfer between a master/communication device and other device like an accessory.

The accessory/remote UI device may include or essentially consist of e.g. an RSM device, vehicle-installed device, a headset, a speaker device, a control device, and/or a microphone device.

In some embodiments, the first and second accessory devices may be utilized by a user to interact with the communication device as alluded herein before. The first device may be utilized for audio/voice signal transfer and the second device may be configured to signal control commands, such as PTT commands, responsive to user actions provided via the UI, such as button(s) and/or touch display/surface, of the second device.

In the communication device functionally connected to the first and optionally second accessories, the audio and/or signaling data transferred between particular accessory and the communication device may be primarily utilized/handled, optionally as is, by a specific communication (end) application/software, which may provide e.g. VoIP, Wi-Fi and/or cellular data based connectivity to the local user towards remote entities, such as remote servers/services, remote users/user terminals, etc. The communication device may optionally further include an intermediate routing or interfacing logic, or the aforesaid interfacing logic or corresponding middleware, for data exchange and optionally conversion purposes.

In one embodiment, such interfacing logic may be at least partially user-controllable. For example, the user may determine the association between the command sent by the accessory such as the RSM and the command providable by the local UI, such as by a PTT button, touch screen or keypad of the communication device. The interfacing logic may be configured to request from the user, upon receiving a command sent by the accessory, an associated local command providable via the local UI. Among other options, visual instructions and/or auditive instructions may be output to the user of the arrangement asking the user to apply, such as depress, a local UI feature to be mated with the received remote command. The logic may be thus trained. In another, either supplementary or alternative, embodiment the interfacing logic may host a plurality of associations between a number of accessory-originated commands and a number of local commands. In a further, either supplementary or alternative, embodiment the interfacing logic may host associations between a plurality of communication applications and an accessory such as an RSM in terms of related commands. A first received external, i.e. accessory-originated, command may be associated with a first local user input command addressed to a first communication application. A second accessory-originated command may be associated with a second local user input command addressed to a second communication application. Thus, a plurality of commands provided by an accessory may be associated with a plurality of local commands and/or communication applications, respectively.

The interfacing logic may even be configured to host associations between a plurality of communication applications and a plurality of accessory devices in terms of related commands. Each accessory may be associated with a number of communication applications.

Yet in a further, either supplementary or alternative, embodiment an accessory-originated command may be associated with a plurality of local commands to be generated in response. Alternatively or additionally, a plurality of accessory-originated commands, received in sequence, for example, may be associated with a certain local command.

Still in a further, either supplementary or alternative, embodiment, the interfacing logic may host a number of optionally user-selectable and/or controllable configurations, each configuration comprising at least a number of, potentially a plurality of, associations, wherein each association links at least one accessory-originated command to at least one local user input command.

In an embodiment, a method for transferring audio data and signaling between at least one accessory device and a communication device running a communication application, may be provided for execution by a communication device, such as a smartphone, comprising wirelessly receiving audio data such as voice data, sent by a first accessory/remote UI device such as an RSM device, over a first wireless connection, preferably Classic Bluetooth™-compliant connection, and

receiving signaling information preferably including an indication of user depressing or otherwise actuating a button, e.g. PTT button, or other UI feature of the first or second accessory, over a second, different wireless connection, preferably Bluetooth Low Energy (BLE, Bluetooth LE or Bluetooth Smart)™.

The audio data and signaling may be forwarded within the communication device to the target communication application as such or in a converted/mapped/adapted format (refer to the interfacing logic).

Yet in a further embodiment, a method for execution by an accessory device or arrangement comprising at least first and second accessory devices capable of wireless communication with a master communication device, optionally a smartphone, comprises transmitting to or generally communicating audio data, such as voice signals, with the communication device over a first wireless connection, preferably Classic Bluetooth™-compliant connection, and transmitting or generally communicating therewith related signaling information, optionally including transmitting an indication of depressing or otherwise actuating a button, e.g. PTT button (to activate audio/voice transmission), or other UI feature of the first or second accessory, over a second, different wireless connection, preferably compliant with Bluetooth Low Energy (BLE, Bluetooth LE or Bluetooth Smart)™.

In some embodiments, a computer readable non-transitory carrier medium, such as an optical disc or a memory card/stick, may be configured to store a computer program, which when executed by computing element(s), e.g. processing unit(s), of the communication device, provides any of the aforesaid functionalities of the communication device, or related method, thereto provided that the device itself also contains the necessary hardware for the purpose including sufficient processing, memory, and data transfer components as being appreciated by a skilled person.

Correspondingly, in some other embodiments, a computer readable non-transitory carrier medium, such as an optical disc or a memory card/stick, may be configured to store a computer program, which when executed by computing element(s), e.g. processing unit(s), of at least one accessory/remote UI device, provides any of the aforesaid functionalities of the accessory device, or related method, to the target device further containing necessary processing, memory, and data transfer components.

Also in more general terms, the various considerations presented herein concerning different embodiments of the communication and accessory devices may be flexibly applied to the embodiments of the method or computer program mutatis mutandis, and vice versa, as being appreciated by a skilled person.

The utility of the present invention follows from a plurality of issues depending on the particular embodiment thereof. Using preferred communications technology such as Bluetooth Low Energy™ for sending PTT or other control commands/signaling and preferred other technology, e.g. Classic Bluetooth™, for transmitting the actual audio, greatly reduces the delay associated with a response to control commands, such as activating audio/voice signal transmission from the communication device during PTT conversation (the resulting delay may be in the order of magnitude of 10-20 ms only, for instance), and the power consumption of the concerned device(s) is significantly lowered as well in contrast to prior solutions potentially utilizing e.g. Classic Bluetooth both for audio transfer and signaling.

Further, communication device-triggered remote wake up or activation of the accessory device (or related more specific features thereof) over e.g. BLE is a clear advantage when compared to clumsier prior arrangements requiring separate manual actions potentially on both the communication device and the accessory/remote UI.

Yet, the present invention enables utilizing several different accessories with the same communication software running on the communication device. The devices may be functionally dedicated and utilized in connection with a common session or call, but for different purposes such as audio/payload data transfer and the transfer of user initiated control commands towards the communication software.

The verb “to comprise” is used in this document as an open limitation that neither requires nor excludes the existence of also unrecited features.

The expression “a number of” refers herein to any positive integer starting from one (1), e.g. to one, two, or three.

The expression “a plurality of” refers herein to any positive integer starting from two (2), e.g. to two, three, or four.

The expression “data transfer” may refer to transmitting data, receiving data, or both, depending on the role(s) of a particular entity under analysis relative a data transfer action, i.e. a role of a sender, a role of a recipient, or both. Similarly, the term “communicate” may herein refer to transmitting, receiving, or both transfer directions.

The terms “a” and “an” do not denote a limitation of quantity, but denote the presence of at least one of the referenced item.

The terms “first” and “second” do not denote any order, quantity, or importance, but rather are used to distinguish one element from another.

### BRIEF DESCRIPTION OF THE FIGURES

Various embodiments of the invention presented in the sense of examples and their potential advantages are explained in greater detail below with reference to the accompanying drawings, in which

FIG. 1 depicts the concept of the present invention via few embodiments thereof and a related potential use scenario,

FIG. 2 is a block diagram of a device in accordance with an embodiment of the present invention,

FIG. 3 is a flow chart of a method according to an embodiment of the invention,

FIG. 4 illustrates an embodiment of an accessory/remote UI device having five dedicated buttons for e.g. PTT applications,

FIG. 5 depicts an embodiment of communication app control via the accessory/remote UI device,

FIG. 6 shows how in some embodiments multifunction buttons or other multifunction UI features may be exploited in the accessory,

FIG. 7 shows further examples of how multifunction buttons or other multifunction UI features may be exploited,

FIG. 8 illustrates few examples of UI feature/button allocations possible in the accessory device,

FIG. 9 illustrates a example of a scenario for NRT communications, and

FIG. 10 illustrate an example on audio transport according to an embodiment of the invention.

### DETAILED DESCRIPTION

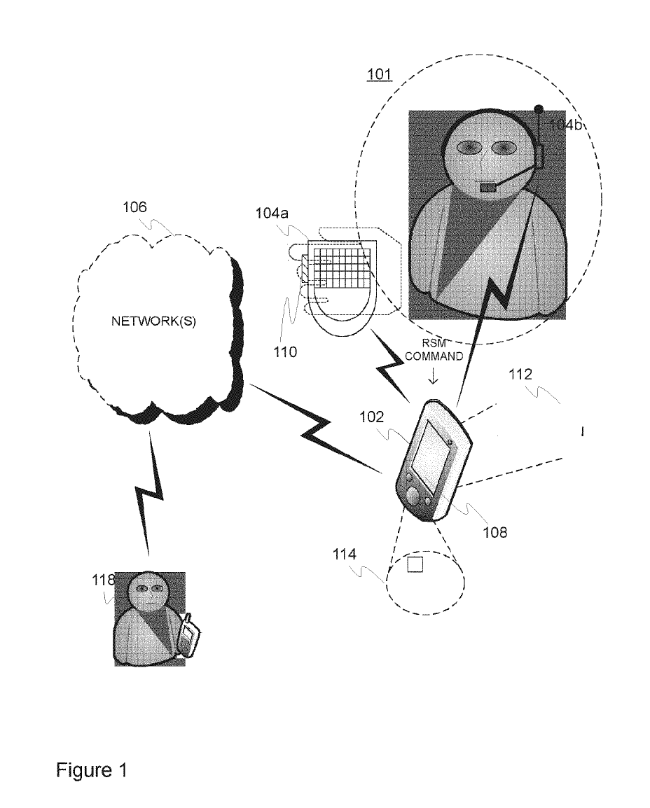

FIG. 1 (not in scale) illustrates the concept of the present invention via two embodiments thereof. The user entity 101 may be provided with a (mobile) communication device 102, such as a cellphone, a smartphone, tablet, phablet, a walkie-talkie, or e.g. a communication-enabled PDA (personal digital assistant), capable of wireless communication with a remote party 118 optionally via at least one network infrastructure 106, such as a cellular network, a wireless local area network (Wi-Fi), etc. The communication between the parties may naturally generally take place over the Internet and/or cellular networks and via appropriate communication platforms such as communication services, communication (client) software/applications 112 installed at the devices 102, etc.

An accessory or ‘remote UI’ device, such as an RSM 104a, 104b (headset, which may be a stand-alone headset potentially with own UI feature(s) such as a PTT control button, or a supplementary headset to be used in connection with other device(s) such as the RSM 104a), may be wirelessly providing data including e.g. user-initiated control commands (e.g. PTT, see UI feature 110) and voice (typically speech) data to the device 102 for use with the communication application 112 running thereon. The communication application 112 may be a PoC and/or VoIP application, for instance. Preferably, audio such as voice signals are wirelessly transferred between the accessory/accessories 104a, 104b and device 102 using a first wireless connection/technology and related signaling such as user-provided control commands are provided using a second wireless connection/technology. These may include Classic Bluetooth™ and Bluetooth Low Energy™, respectively. Classic BT supports different applicable audio transfer profiles whereas BLE enables provision of commands such as PTT commands to activate voice transmission with reduced delay.

The device 102 may optionally comprise interfacing logic 114, such as middleware, to preferably automatically convert the received, accessory-originated command into a proper local counterpart, when possible. The device 102 may contain a data repository such as a mapping table and/or a database (or “mapping rules” in general) for storing related mapping information enabling the generation of a proper local command based on the received remote one.

The mapping rules may be at least partially user-controllable, i.e. the user may affect the linkage between a received command and a local command providable via the built-in (local) UI 108 of the device 102.

The interfacing logic may thus conceptually match a button or other UI feature on the accessory 104a, 104b with a button or other UI feature on the device 102. This may be materialized such that as an activation of an RSM button or other UI feature causes a first, RSM-originated command, i.e. predetermined signal/data that can be interpret as a command, to be transmitted to the mobile device 102 and be thus detectable by the device 102, the received command (predetermined signal/data) may be mapped to an activation of an associated button or other local UI feature of the device 102 by causing the receipt of the first command to locally generate, in the device 102, a second command conventionally triggered by the direct local input via the UI.

The nature of the second command mimicking local UI input may differ between different embodiments of the present invention and even within a single embodiment. Namely, in some cases the second command may be related to a lower level command, e.g. for a lower level API, and in some other cases to a higher level command, e.g. for a higher level API. For example, the second command may just indicate an activation of a certain local UI feature, such as a certain button or key press, to the communication application, and/or it may directly indicate more cultivated, higher-level, information such as desired target function, e.g. a request for transmission permission (PTT), in which case the device 102 may, externally to the actual communication application, first convert the UI input-related lower level information (e.g. a button press) to a higher-level more conceptual information (e.g. request for transmission permission), and then provide the application with at least the higher-level information.

The same generally applies to the first, i.e. RSM-generated, command. It may indicate a lower level action such as a certain key press taken place in the RSM 104a, 104b, and/or a higher level action like a request for transmission permission. Further, the first and/or second command may effectively indicate also both, as depressing a predetermined PTT button, for example, usually simultaneously implies also a request for transmission permission.

In some embodiments, the user may determine, such as select from a predetermined list or type in, a wirelessly received (RSM) command and an associated local UI input-based command utilizing the UI 108 of the mobile device 102, such as keypad (button(s)) or a touch screen, and that way facilitate the pairing procedure between the received RSM command and local user input.

In some embodiments, the mobile device 102 may be configured to monitor both the data traffic, such as a command received from the RSM, and the local UI input for pairing purposes.

The device 102 may facilitate entering a pairing procedure. This may happen automatically upon receipt of an unrecognized command from the RSM and/or when requested by the user via the local UI 108. During pairing, the user may trigger sending an RSM-initiated command wirelessly to the mobile device 102 by operating associated UI feature of the RSM 104a, 104b. For example, an UI feature 110 such as a button like a PTT button of the RSM 104a, 104b may be activated, such as depressed and/or released, or voice input be given by the user to trigger the transmission, optionally in response to a corresponding request indicated by the device 102 to the user via a display and/or loudspeaker, for example.

The device 102 may acknowledge the receipt of an RSM command and optionally provide the user with an opportunity to check the received command e.g. via a display and further optionally to alter or change it, if needed.

Then the user may preferably apply the local UI 108 of the mobile device 102 to indicate the target command of the pairing action to the mobile device 102 optionally again in response to a corresponding request indicated by the mobile device 102 via a display and/or a loudspeaker, for example.

Advantageously the communication application 112 whereto the converted, now local-like input is provided may remain unaware of the actual origin (RSM) of the input. The interfacing logic 114 taking care of the conversion may preferably funnel the resulting RSM-tnggered commands to the application 112 via the same interface as being used with commands truly locally input via the UI 108.

The UI of the RSM 104a, 104b and/or the device 102 may support voice commands and include a speech recognition logic entity for the purpose.

Preferably, the communication device 102 may wirelessly wake up or activate accessory/accessories 104a, 104b, or at least different functions, features, or states thereof. A predetermined signal or signals may be utilized for the purpose. The activation may take place upon establishing a communication connection such as a call via the application 112, for example.

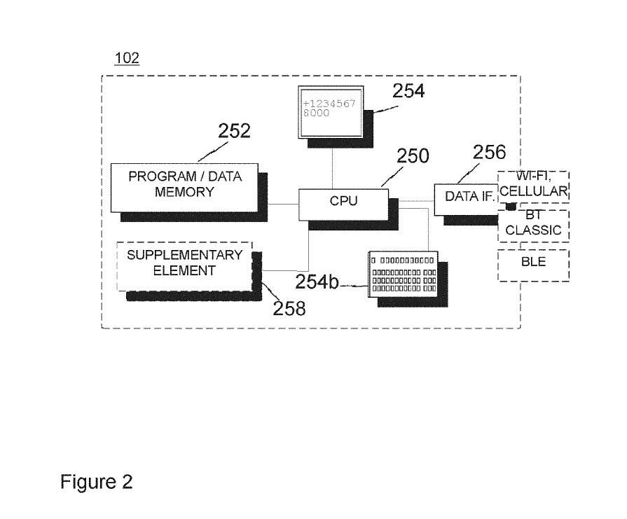

FIG. 2 is a block diagram illustrating the selected internals of an embodiment of various device(s) such as the communication device 102 presented herein. Basically, an accessory device, such as an RSM, can include substantially same or similar entities as well depending on the embodiment thereof. The entity 102, such as a cell phone, tablet, or the aforesaid RSM, may contain a plurality of at least functionally connected elements. It is typically provided with one or more processing devices capable of processing instructions and other data, such as one or more microprocessors, micro-controllers, DSP's (digital signal processor), programmable logic chips, etc. The processing entity 250 may thus, as a functional entity, comprise a plurality of mutually co-operating processors and/or a number of sub-processors connected to a central processing unit, for instance. The processing entity 250 may be configured to execute the code stored in a memory 252, which may refer to instructions and data relative to the software logic and software architecture for controlling the device 102. The processing entity 250 may at least partially execute and/or manage the execution of the audio data and signaling/command handling tasks, tasks of the communication application, and optionally implement the interfacing logic with the memory 252.

Similarly, the memory entity 252 may be divided between one or more physical memory chips or other memory elements. As alluded above, the memory 252 may store program code and other data such as audio data, command mappings, etc. The memory 252 may further refer to and include other storage media such as a preferably detachable memory card, a floppy disc, a CD-ROM, or a fixed storage medium such as a hard drive. The memory 252 may be non-volatile, e.g. ROM (Read Only Memory), and/or volatile, e.g. RAM (Random Access Memory), by nature. Software (product), such as the middleware, applied for implementing an embodiment of the present invention may be provided on a carrier medium such as a memory card, a memory stick, an optical disc (e.g. CD-ROM or DVD), or some other memory carrier.

The UI (user interface) 254, 254b may comprise a display or a data projector 254, and a keyboard/keypad or other applicable user (control) input entity 254b such as a touch screen and/or voice control input (requires a microphone or corresponding transducer), or a number of separate keys, buttons, knobs, switches, a touchpad, a joystick, and/or a mouse, configured to provide the user with practicable data visualization and device/application control features, respectively. The UI 254, 254b may include one or more loudspeakers and/or beepers (buzzers), and associated circuitry such as D/A (digital-to-analogue) converter(s) for sound output and/or a microphone with A/D converter for sound, e.g. speech, input. Further, an accelerometer may be used for providing user input. A tactile output device such as a vibration element may be applied for providing tactile output.

The device 102 further comprises a data interface 156 such as a number of wireless and optionally wired transmitters, receivers, and/or transceivers for communication with other devices such as accessories, terminals or network infrastructure(s). For example, an integrated or a removable network adapter may be provided. Non-limiting examples of the generally applicable technologies include WLAN/Wi-Fi (Wireless LAN, wireless local area network), LAN, Ethernet, USB (Universal Serial Bus), GSM (Global System for Mobile Communications), GPRS (General Packet Radio Service), EDGE (Enhanced Data rates for Global Evolution), UMTS (Universal Mobile Telecommunications System), WCDMA (wideband code division multiple access), CDMA2000, PDC (Personal Digital Cellular), PHS (Personal Handy-phone System), and different Bluetooth technologies.

For the information transfer between the communication device and accessory/accessories, preferably at least two transfer technologies are supported in the concerned devices, optionally Classic Bluetooth (voice) and Bluetooth Low Energy (control commands). Either Bluetooth variant may be implemented using a dedicated chip, for instance. Accessory for providing only control commands (actuated via button presses, for example) may contain Bluetooth Low Energy chip only whereas other accessory used for audio transfer may implement (solely) Classic Bluetooth for such purpose. Alternatively, both transceivers may be included in the same accessory/remote UI device or element. In some embodiments, multi-mode transceivers (chips) could be utilized particularly if they are found truly supporting simultaneous usage of both BT modes.

It is clear to a skilled person that the device 102 may comprise numerous additional functional and/or structural elements for providing advantageous communication, processing or other features, whereupon this disclosure is not to be construed as limiting the presence of the additional elements in any manner. Entity 258 refers to such additional element(s) potentially found useful depending on the embodiment.

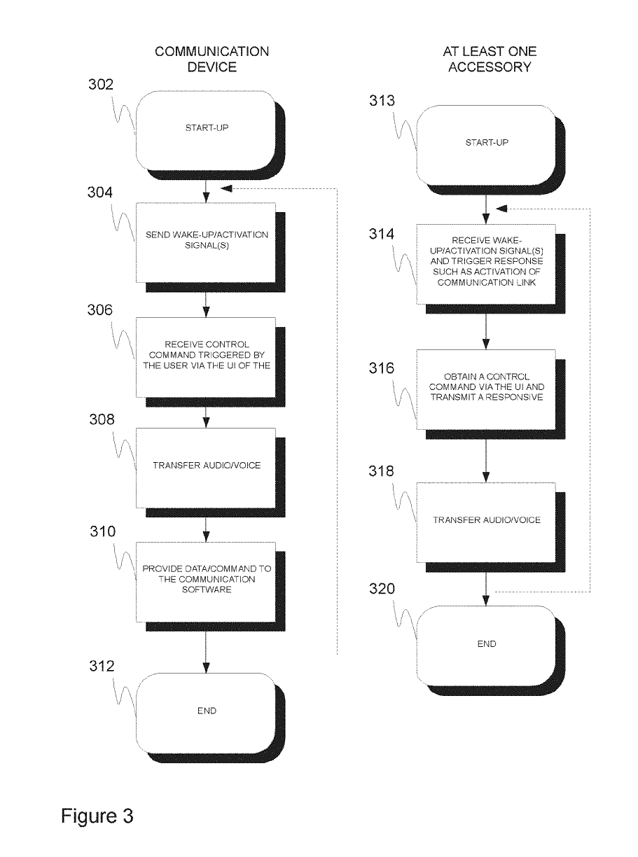

FIG. 3 discloses, by way of example only, a method flow diagram in accordance with two embodiments of the present invention. At 302, 313 the device(s) of the present invention (communication device, a number of accessories/remote Uls) are obtained and configured, for example through loading and execution of related software. On the left, method taking place at a communication device is shown, while activities on the accessory side are depicted on the right.

Item 304 refers to sending a wake-up signal (optional) or potential other activation or configuration message to accessory/accessories. BLE is preferably applied for the purpose due to its low latency.

Item 306 refers to receiving a control command from an accessory. It may be provided to the communication application 310 as is or as converted/mapped by interfacing logic as discussed hereinbefore. The communication application may act accordingly. The command such as a PTT command may instruct establishing or terminating voice transmission (link), for instance.

Item 308 refers to receiving audio data from an accessory (same or different accessory than the command-providing one) and/or transmitting audio data (from the communication application) thereto. Received data may be provided to the communication application 310 for possible forwarding towards remote recipient(s) such as remote parties of a call.

Correspondingly, item 314 refers to receiving a wake up signal at the accessory/remote UI device and acting accordingly (ramping up a voice/data link, for example).

Item 316 refers to obtaining control command via the UI of the accessory from the user. The command may be provided by pressing a button of the UI, such as PTT button, for instance, or actuating other feature of the UI. In case the command is not for local adjustments only (e.g. for the volume adjustment of the loudspeaker of the accessory), an associated control signal may be transmitted to the communication device to establish or activate an audio link, for example.

Item 318 refers to sending audio data to and/or receiving audio data from the communication device. The audio data may include call-related voice data, for example.

A skilled person will realize that e.g. the mutual order of many method items may vary or be reversed depending on the circumstances. Dotted loop-back arrows indicate the likely repetitive nature of the execution of the shown method items.

A computer program, comprising a code means adapted, when run on a computer, to execute an embodiment of the desired method items in accordance with the present invention, may be provided. A non-transitory carrier medium such as an optical disc, floppy disc, or a memory card, comprising the computer program may further be provided. The program may be delivered over a communication network.

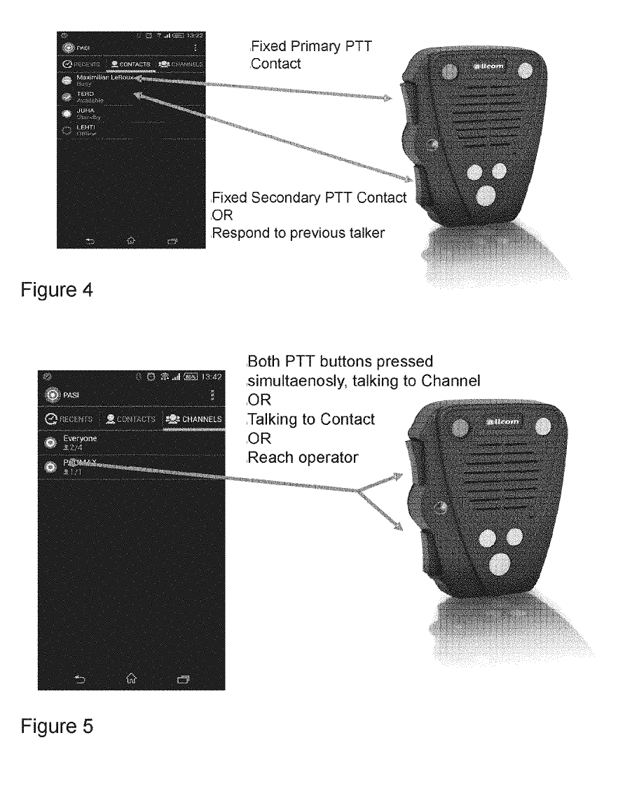

In FIG. 4, an embodiment of a ‘snappy’ accessory/remote UI device according to present invention has five buttons on the front surface for e.g. PTT applications. Each detected button event may be configured to send a predetermined (PTT) command for controlling the communication application accordingly in the communication device such as a smartphone. Different button combinations may be configured (i.e. the response of the communication application in the communication device to different button presses may be determined) to suit one's needs. Preferably, such configuration is user-adjustable via the accessory and/or the communication device or application.

According to an embodiment of the invention, FIG. 4 demonstrates also at the left side of the accessory/remote UI device, additional buttons indicated by arrows (the accessory/remote UI device at the right side of the sheet), for functionality of Fixed Primary PTT Contact, and Fixed Secondary PTT Contact or Respond to previous talker. The arrows at their left end are indicative to associate the button and/or the function/command at the right end of each arrow to a detail on the view of the communications device and/or an operation of the communication device, as activated by the operation of the button in the example.

In the scenario of FIG. 5, multiple, essentially two, UI features, such as buttons, of an accessory device have been harnessed to control even a greater number of functions in the communication software of the communication device via separate button presses and a simultaneous press, for instance. Alternatively or additionally, different sequences of UI feature activations such as button presses could be configured in various embodiments to trigger predetermined, dedicated responses in the software.

The branching arrow between the communication device (left) and the accessory device (right), at the accessory side pointing the two buttons is indicative of an illustrated situation in which the view on the screen of the communications device (left) and/or a related function of it is achieved by having both PTT buttons pressed simultaneously, so facilitating talking to a channel or to a contact or reach operator. These examples explained in FIGS. 4 and 5 are only examples of the configuration of some buttons, and may be differently configured by a different user, and/or service provider as an operator.

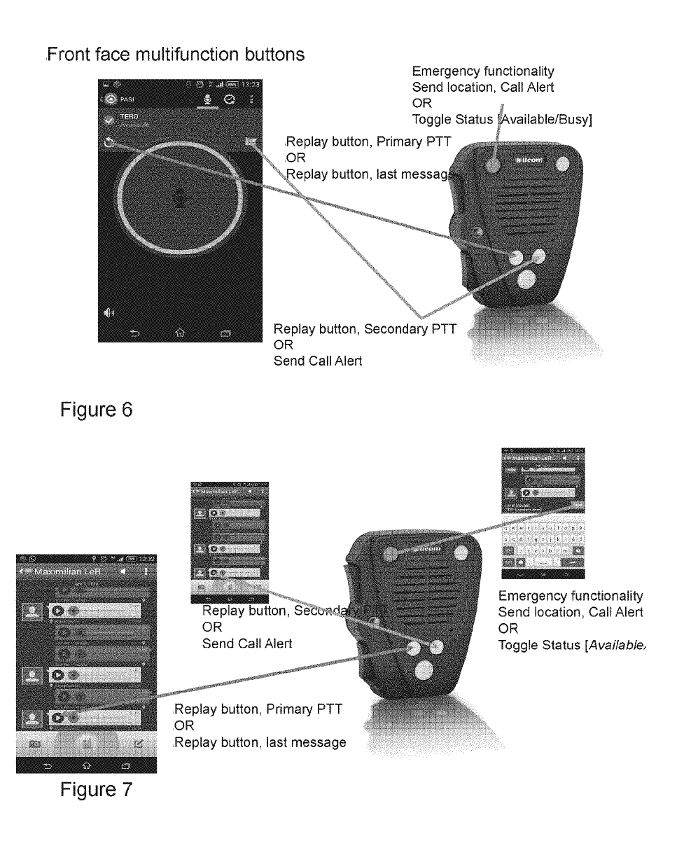

FIG. 6 indicates how in some embodiments multifunction buttons (or other multifunction UI features) could be applied. The response may depend on the context such as particular mode, display view, state, etc. of communication device or specifically communication software upon the activation, for example.

For example emergency functionality button at the upper left corner of the accessory device (the device at the right hand side of the sheet) can be configured to send location, or call an alert according to the configuration made. In this example the button can be also operated optionally to toggle status between certain modes, in the example as illustrated for example available and busy.

The broken conical array from the communication device's (at left on the sheet) right side to the lower ensemble of buttons, the button at upper right of the accessory device (at left on the sheet) is configured to operate as a replay button, a secondary PTT or to send call alert, for example. At the left end of the array line, the feature is indicated on the communications display.

The straight line from the communication device's (at left on the sheet) left side to the lower ensemble of buttons, the button at upper left of the accessory device (at left on the sheet) is configured to operate also as a replay button, but as a primary PTT or as a replay button for last message, for example. At the left end of the array line, the feature is indicated on the communications display.

FIG. 7 visualizes other option for multifunction UI feature exploitation.

According to an example in the illustration in FIG. 7, in the view, three separate communication devices are shown surrounding the accessory device (essentially in the middle) are demonstrated. To right side communication device (at right on the sheet), the line from the button of the accessory device's upper left corner, symbolically connects the button and the functionality at the communications device, which is configured to activate as an emergency functionality to send location, call alert, or to toggle status (available/busy).

The communication device at the middle illustrate a view on the display of the device when the button of the accessory device's at its lower ensemble, the upper right corner is used to activate replay as a secondary PTT or to send call alert. The association of the button and the functionality according to the configuration is indicated by the line connecting the feature at the communication device's screen and the button just indicated.

The communication device at the left illustrate a view on the display of the device when the button of the accessory device's at its lower ensemble, the upper left corner is used to activate also a replay but as a primary PTT or to replay a last message. The association of the button and the functionality according to the configuration is indicated by the lowest line connecting the feature at the communication device's screen and the button just indicated.

According to an embodiment of the invention views exemplified in figures for a communication device's display and the shown associated functionalities are those of the same communications device. According to an embodiment, then the views represent examples on different configurations of the buttons of the accessory device. According to an embodiment of the invention said different configurations are made to one but a different communication device, so indicating the configuration versatility. According to an embodiment all three communications devices are separate, to be operated with the same accessory device, whose buttons are dedicated to the communications devices respectively according to the examples as explained, but operable to point even simultaneously or essentially simultaneously to the dedicated communication device according to the configuration of the PTT button in question and the functionality of the particular communication device in question.

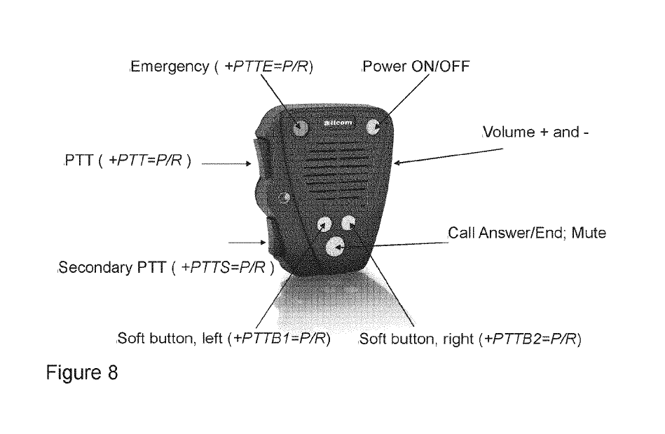

FIG. 8 illustrates few examples of UI feature/button allocations possible in the accessory device in accordance with an embodiment of the present invention.

According to an example illustrated in FIG. 8, the accessory device is configured to activate and/or use in a communication device as follows: The upper left corner button is associated in the configuration to emergency (+PTTE, P/R), the upper right corner to switch power on/off (in one embodiment example only the accessory device, but in another a configurable ensemble of communication devices and/or accessory devices). The right middle at the accessory device, controlling the Volume +/−, at the ensemble of the buttons at the bottom side, the most down button is configured to call answers/to end or to mute, the up-right button in the same ensemble of buttons, it is configured to operate as a soft button (PTT B2, P/R) as a secondary button, for example, the up-left button in the same ensemble of buttons, it is configured to operate also as a soft button (PTT B1, P/R) as a primary button, for example. According to an embodiment of the invention the soft button can be operated according to the software configuration. According to an embodiment the configuration comprises an associated functionality to a soft button that is an adjustment of a quantity having a continuous nature, such as a volume or tone of the sound, but according to an embodiment variant also a switching-type operations can be addressed to this kind of buttons via the configuration.

At the lower left side the accessory device has a secondary PTT button (PTTS, P/R) and at the upper left side a PTT (P/R) button.

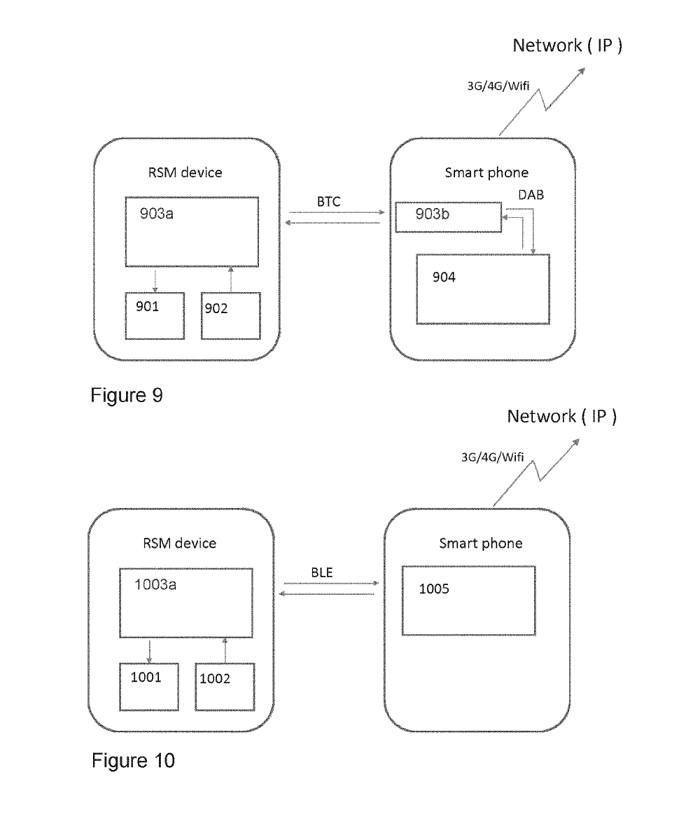

FIG. 9 illustrates an example of a Non Real Time (NRT)-communications according to an embodiment of the invention. In this embodiment there are illustrated an RSM device and a Smart phone, as respective examples of an accessory device and a communication device 102. The example of FIG. 9 illustrates that there is a certain delay in audio coding and decoding in a smart phone, when using BTC-communication link, i.e. Bluetooth Classic communication link as illustrated. The RSM device in the embodiment uses an Audio codec 903a, (Bluetooth Classic CVSD) for the audio being internally transferred between the audio codec 903a, Speaker 901 and Microphone 902 of the RSM device to pass audio signal. The codec 903a of the RSM-device communicates over the BTC communication link with the Audio codec 903b in the Smart phone, the codec 903b being compatible with the 903a in their mutual communication.

According to this embodiment, the Decoded audio bit stream, DAB, is further internally communicated in the smart phone to a communication application 904. The application 904 can also have a proprietary audio codec (P.25/Speex/etc), or it 904 can have an access to an audio codec in the smart phone's resources, to be used for the purposes of further communications of audio signals from the smart phone, via a communications link illustrated by the 3G/4/Wifi associated arrow. The arrow is indicative of communication example via a communications network (IP).

The above mentioned delay is thus demonstrated being caused by a double use of audio codecs, thus causing a further delay to the signal processing in the smart phone and thus to the signal being used in the communications via the network.

But it is not only the delay, that is experienced as problematic in the use of two codings with a number of lossy different codecs in the audio coding. Such can namely cause also significant audio quality degradation and loses the intelligibility. Such an extra delay by a second coding can be excess of 50 ms, typically 100 ms. A Non Real Time (NRT) communications is a result of this scenario, which thus often cannot meet the 3GPP RT standard of 300 ms delay from a microphone 902 to network (IP).

Link opening time can be 400 ms to 2000 ms, which is too long lag for professional PTT use, and cannot shut down link when not used, which thus leads to high power consumption.

BTC audio communication also needs the use of inconvenient pairing procedure. Also user errors as well as variation between phone brands and models cause negative effects that would need to be avoided.

In FIG. 9 the signaling of the RSM-device and the Smart phone can be performed according to a BLE-communications link as a second communications link. However, the use of signaling by the BLE does not reduce the audio signaling delay, nor the degeneration of the audio signal by the repeated codings by lossy codecs.

FIG. 10 illustrates how the problems in the audio transference illustrated in the FIG. 9 can be solved. In the embodied example of FIG. 10, in the RSM device it is possible to use a compatible audio codec 1003a, which can be a proprietary audio codec (P.25/Speex/etc). The audio codec 1003a can communicate audio signals with the speaker 1001 and/or the microphone 1002 of the RSM-device. According to an embodiment of the invention, in the smart phone there is no need of extra use of codecs by the communication application 1005, when there is used Bluetooth Low Energy (BLE)-communications link for passing audio to the network.

This way, as illustrated in the embodiment of FIG. 10, the delay is smaller than in example of FIG. 9, and thus facilitating Real Time communication standard (300 ms total delay) to be achieved.

The embodiments in FIG. 10 may also facilitate the best audio quality possible, as all the coding and decoding takes place at the User Interface (UI), i.e. the RSM device. Link opening time is only few milliseconds, and thus the link can be shut down when not in use. This allows significant power savings, as the power consumption can easily get reduced to 1/10^{th}- 1/100^{th} vs the scenario in FIG. 9 with the BTC.

Additionally, no pairing procedure of BTC is needed with the BLE-connection. Thus the setup of the connection between the smart phone and RSM device is easier than in FIG. 9 scenario. Also the phone brand/model dependence does not exist or have such a notable role as in the scenario of FIG. 9. According to an embodiment the BLE is be used also in signaling in the FIG. 10 example, thus avoiding the BTC related delays and the pairing of the devices.

Consequently, a skilled person may on the basis of this disclosure and general knowledge apply the provided teachings in order to implement the scope of the present invention as defined by the appended claims in each particular use case with necessary modifications, deletions, and additions.

Yet, instead of the pronouncedly set forth RSM, the applied accessory could practically be any other suitable device or an aggregate entity of a plurality of at least functionally connected elements external to the arrangement and feasible for controlling the arrangement-run target application. For example, different headsets or in-car, or generally in-vehicle, electronics device(s) or entitie(s), which may include command input and potentially also sound such as speech input element(s), may be mobilized for the purpose.

In some embodiments, an in-vehicle entity, which may refer to a multimedia control system or other substantially integrated user interface, for instance, can receive user input an indication of which is then relayed preferably wirelessly to the mobile arrangement for optional adaptation and delivery to the communication application. In a general sense, even the vehicle itself can be considered as the accessory from the standpoint of the mobile arrangement and the present invention.

Ultimately, instead of wireless communication, even wired transmission could be applied between the accessories and the arrangement.

1-21. (canceled)

22. A communication device comprising a configuration for hosting a communication application and/or software, such as a PTT/VoIP application, for communication of audio data, such as voice data, with a wirelessly connected first accessory over a first wireless connection, such as Classic Bluetooth-compliant connection or Bluetooth Low Energy-compliant connection (BLE, Bluetooth LE or Bluetooth Smart), the communication device being further configured to be at least partially controlled and supplemented with payload data by at least one accessory to provide remote UI features and/or capabilities, the signaling being configured to occur via a second wireless connection, preferably Bluetooth Low Energy-compliant connection (BLE, Bluetooth LE or Bluetooth Smart).

23. The communication device of claim 22, wherein the communication device has been provided with an access to/from at least one, but optionally two or more accessory devices of which at least one is configured to control at least one of the communication device and a communication application of said communication device substantially simultaneously.

24. The communication device of claim 20, wherein it comprises such a configuration for the controlling of the communication, the configuration being adapted to at least to a same communications connection or session comprising at least one of said communication devices and at least one of said two or more accessory devices in the session or in the communications connection.

25. The communication device of claim 22, wherein it has a configuration for an accessory device for a user input command to the communication device and/or a configuration for an accessory device for audio and/or voice data transfer.

26. The communication device of claim 22, wherein the communication device comprises at least one of the following: a cellular phone, a so-called smartphone or a communications-enabled PDA, a tablet, a phablet, and a vehicle-installed communication equipment.

27. An accessory device for a wireless communications with a communications device of claim 22, the accessory device being configured with a first configuration to transmit to or generally communicate audio data, such as voice signals, with a communication device over a first wireless connection, which comprises using Classic Bluetooth-compliant connection and/or Bluetooth Low Energy connection (BLE).

28. The accessory device of claim 27, wherein the accessory device is further configured with a second configuration, to communicate therewith related signaling information, optionally including transmitting an indication of depressing or otherwise actuating a button, e.g. PTT, or other UI feature, over a second, different wireless connection, preferably compliant with Bluetooth Low Energy (BLE, Bluetooth LE or Bluetooth Smart).

29. The accessory device of claim 27, wherein the accessory device comprises a number of, or preferably a number of or a plurality of, user actuable such as manually actuable UI features such as a number of buttons, switches, keys, and/or a touch display/surface that are arranged to locally control feature(s) of the accessory device and/or be associated with predetermined control signal(s) transmitted wirelessly over a second connection to control the communication device via an application running thereon.

30. The accessory device of claim 27, wherein the accessory device has a configuration for setting the accessory device into a certain mode, which comprises at least one of a sleep mode, active mode, off-mode, stand-by mode or idle mode and a mode determined by another feature thereof such as a communications feature, which feature may be triggered on/off as responsive to a predetermined signal received over the second connection, preferably BLE, e.g. from the communication device.

31. The accessory device of claim 27, wherein said accessory device is configured for communication as a first accessory device to a master/communication device and/or other device, like said first accessory device, to, a second accessory device operating as a master device to the first accessory device.

32. The accessory device of claim 31, wherein said communication comprises a signal responsive to user action on the (integral) UI of the communication device itself and/or to a predefined event occurring at the communication device, such as launching of a communication application, establishing a connection or call therethrough.

33. The accessory device of claim 31, wherein it is configured to operate at least as one of a first accessory device and a second accessory device, to communicate with BLE connection or substantially a connection obeying a similar protocol, and wherein said accessory device is said first accessory device or said second accessory device.

34. The accessory device of claim 31, wherein said accessory device comprises an RSM device, vehicle-installed device, a headset, a speaker device, a control device, and/or a microphone device.

35. An interfacing logic module, wherein said interfacing logic module comprises a user interface access for a user to at least one of the following: to give commands, associate an accessory device for a UI feature, associate an accessory device's PTT button, touch screen or keypad of the communication device, mating a remote command with another remote command.

36. The user interface logic module of claim 35, wherein said module is configured to be locatable into a communication device, an accessory device, or in a diversified manner between said two.

37. A method of communicating in a session or a communication connection, by operating a communication system, which comprises at least one communication device, and in a number of or a plurality of accessory devices at least one accessory device, configured operable together via a user interfacing logic, the method, as executed in the communication device, comprising:
providing wake-up and/or activation signal(s) to the accessory devices;
receiving control command triggered by the user via the UI of the accessory;
transferring audio and/or voice data between a communication device of the system and an accessory device by using at least one of the Bluetooth or BLE protocol,
providing signaling data and/or command to the communication software, by using Bluetooth Low Energy (BLE, Bluetooth LE or Bluetooth Smart), in the command of the interfacing logic.

38. A method of communicating in a session or a communication connection, by operating a communication system, which comprises at least one communication device, and in a number of or a plurality of accessory devices at least one accessory device, configured operable together via a user interfacing logic, the method, as executed in the communication device and/or in an accessory device operable in communication with a communication device, comprising:
receiving wake-up and/or activation signal(s) from a communication device;
trigger response such as activation of communication link;
obtaining control command via the UI and transmit a responsive signal;
transferring audio and/or voice data between the communication device of the system and the accessory device by using at least one of the Bluetooth or BLE protocol,
receiving data and/or command from the communication software, by using at least one of the Bluetooth or BLE protocol, in the command of the interfacing logic.

39. A communications system, comprising at least one communication device, and in a number of or a plurality of accessory devices at least one accessory device, configured operable together via an interfacing logic, according to a communication method as executed, in an accessory device operable in communication with a communication device.

40. The communications system of claim 39, wherein said number of or a plurality of accessory devices comprises at least one of the following: a PTT device, an RSM device, vehicle-installed device, a headset, a speaker device, a control device, and/or a microphone device.

41. The communication system of claim 39, wherein said communication device is at least one in a number of or a plurality of communications devices so comprising at least one of the following: a cellular phone, a so-called smartphone or a communications-enabled PDA, a tablet, a phablet, and a vehicle-installed communication equipment.

42. The communications system of claim 39, wherein said system comprises within at least in said communication device and/or said accessory device a user actuable such as manually actuable UI features such as a number of buttons, switches, keys, and/or a touch display/surface that are arranged to locally control feature(s) of the device and/or be associated with predetermined control signal(s) transmitted wirelessly over a second connection to control the communication device via application running thereon.
